(19) United States
(12) Patent Application Publication
(10) Pub. No.: US 2025/0044224 A1
(43) Pub. Date: Feb. 6, 2025

(54) SUBSTANCE COMPONENT DETECTION APPARATUS AND METHOD

(71) Applicants: HUAWEI TECHNOLOGIES CO., LTD., Shenzhen (CN); Fudan University, Shanghai (CN)

(72) Inventors: Li Zheng, Shenzhen (CN); Wenbin Cai, Shanghai (CN); Yicai Wu, Shanghai (CN); Zijie Mao, Shanghai (CN)

(21) Appl. No.: 18/920,671

(22) Filed: Oct. 18, 2024

Related U.S. Application Data
(63) Continuation of application No. PCT/CN2023/089349, filed on Apr. 19, 2023.

(30) Foreign Application Priority Data
Apr. 20, 2022 (CN) 202210418006.5

(51) Int. Cl. G01N 21/3577

(52) U.S. Cl. CPC G01N 21/3577; G01N 2201/061; G01N 2201/063

(57) ABSTRACT

A substance component detection apparatus and a method are provided to reduce absorption of an infrared signal by a window medium, thereby obtaining abundant fingerprint region signals. The apparatus includes: a sample pool, an infrared optical window, an infrared light source, and a detector. The infrared optical window has a first surface that faces an inner side of the sample pool and that is configured to be in contact with a to-be-detected substance, and a second surface exposed on an outer side of the sample pool. A protruding portion is formed between two adjacent grooves on the second surface, and any protruding portion has an incident surface and an emergent surface. An infrared signal emitted by the infrared light source is irradiated on the incident surface. The detector determines a component of the to-be-detected substance and/or content of the component.

### CROSS-REFERENCE TO RELATED APPLICATIONS

This application is a continuation of International Application No. PCT/CN2023/089349, filed on Apr. 19, 2023, which claims priority to Chinese Patent Application No. 202210418006.5, filed on Apr. 20, 2022. The disclosures of the aforementioned applications are hereby incorporated by reference in their entireties.

### STATEMENT OF JOINT RESEARCH AGREEMENT

The subject matter and the claimed invention were made by or on the behalf of Fudan University, of Yangpu District, Shanghai, P.R. China and Huawei Technologies Co., Ltd., of Shenzhen, Guangdong Province, P.R. China, under a joint research agreement titled “Interfacial Mechanism and Structure-Activity Relationship of Copper Interconnect Additives on Chips”. The joint research agreement was in effect on or before the claimed invention was made, and that the claimed invention was made as a result of activities undertaken within the scope of the joint research agreement.

### TECHNICAL FIELD

This application relates to the field of substance component detection technologies, and in particular, to a substance component detection apparatus and a method.

### BACKGROUND

Generally, specific substance component detection apparatuses are used to perform qualitative analysis and quantitative analysis, for example, infrared spectrum analysis, on substance components. A to-be-detected substance, for example, an electroplating solution used in the field of electroplating process technologies, may include an organic component and/or an inorganic component.

In a practical application of analyzing components of the to-be-detected substance using an infrared absorption spectrum technology, an infrared signal emitted by an infrared light source needs to be irradiated on the to-be-detected substance through an infrared optical window. However, regardless of a specific material used by the infrared optical window, when passing through the infrared optical window, the infrared signal is partially absorbed by the material of the infrared optical window, and consequently the infrared signal is attenuated. This definitely affects accuracy of an infrared absorption spectrum of the to-be-detected substance.

### SUMMARY

Embodiments of this application provide a substance component detection apparatus and a method, to shorten an optical path of an infrared signal in an infrared optical window, and reduce absorption of infrared light by the infrared optical window, so that an infrared signal with a wider band can be detected, thereby improving wideband detection sensitivity based on a surface-enhanced infrared effect thin film.

To achieve the foregoing purpose, embodiments of this application provide the following technical solutions. According to a first aspect, a substance component detection apparatus is provided, including:
a sample pool, an infrared optical window, an infrared light source, and a detector, where the sample pool is configured to accommodate a to-be-detected substance, the sample pool has an opening, and the infrared optical window is mounted at the opening; the infrared optical window has a first surface that faces an inner side of the sample pool and that is configured to be in contact with the to-be-detected substance, and a second surface exposed on an outer side of the sample pool, a plurality of grooves are formed on the second surface, a plurality of protruding portions are formed between two adjacent grooves, and any protruding portion has an incident surface and an emergent surface that are opposite to each other; an infrared signal emitted by the infrared light source is irradiated on the incident surface and reaches the first surface; and the detector is configured to receive the infrared signal that is reflected by the first surface and that is emitted through the emergent surface, where the infrared signal is an infrared signal of the component that is of the to-be-detected substance and that is adsorbed on the first surface, and is used to determine the component of the to-be-detected substance and/or content of the component. The plurality of grooves are formed on the second surface. This is equivalent to reducing thicknesses of a plurality of regions on the infrared optical window. Therefore, an optical path of the infrared signal passing through the window medium is shortened, and absorption of a fingerprint region signal by the infrared optical window is reduced, so that the detector can receive abundant fingerprint region signals, and a detection lower limit (namely, a minimum concentration that can be detected) for content of a component of the to-be-detected substance is reduced. This shows high sensitivity.

In an embodiment, the plurality of grooves are all strip-shaped grooves, for example, trapezoidal grooves or triangular grooves, and extend in a same direction. This structure design means that the protruding portions are also strip-shaped and extend in a same direction, and further means that two opposite side surfaces of each protruding portion are also strip-shaped, that is, an incident surface and an emergent surface of an infrared signal are strip-shaped and extend in a same direction. Extension directions of the foregoing three are the same. It should be understood that the strip-shaped incident surface can greatly increase a light receiving area, so that more infrared signals can be irradiated on the component of the to-be-detected substance. In addition, a plurality of strip-shaped incident surfaces extend in a same direction, so that identity of requirements of the plurality of strip-shaped incident surfaces on an infrared signal transmission direction can be ensured, and the strip-shaped incident surfaces are ensured to have same effective light receiving areas. Further, effective light receiving areas of the plurality of strip-shaped incident surfaces can be simultaneously adjusted by adjusting the direction in which the infrared light source emits the infrared signal.

In an embodiment, the plurality of strip-shaped grooves are distributed in an array in a direction perpendicular to the extension direction of the strip-shaped grooves. This distribution design means that spacings between any two adjacent strip-shaped grooves are equal, and there is no excessively large spacing or excessively small spacing. In this way, a case in which an excessively small spacing affects mechanical strength of the infrared optical window or a case in which an excessively large spacing leads to a waste of a region on the second surface and a decrease in a quantity of strip-shaped grooves that can be formed, and further affects implementation of technical effect of shortening an optical path are avoided.

In an embodiment, a cross-section of the strip-shaped groove in a direction perpendicular to the second surface is trapezoidal or triangular, and included angles between the second surface and both the incident surface and the emergent surface that are opposite to each other on the protruding portion are both acute angles. In this way, an effective light receiving area of the incident surface is larger.

In an embodiment, a ratio of a spacing between two adjacent grooves to a top width of the groove ranges from 0.5 to 40. The ratio is designed within a proper range, so that an excessively wide groove or an excessively large spacing between grooves can be avoided. Further, a case in which the excessively wide groove is unfavorable to mechanical strength of the infrared optical window or a case in which the excessively large spacing leads to a waste of a region on the second surface and a decrease in a quantity of grooves that can be formed is avoided.

In an embodiment, a size of the infrared optical window in an extension direction of the groove ranges from 2 mm to 11 mm, and a size of the infrared optical window in a direction perpendicular to the extension direction of the groove ranges from 2 mm to 11 mm. The top width of each groove ranges from 0.01 mm to 0.2 mm. The top width of the groove herein may be understood as a width of a top opening of the groove, or understood as a span of the groove in the direction perpendicular to the extension direction of the groove. In addition, a top width of each protruding portion ranges from 0.1 mm to 0.4 mm, and the top width of the protruding portion herein may be understood as a spacing between two adjacent grooves. In addition, a length of each groove ranges from 2 mm to 10 mm, and the length of the groove herein may be understood as a distance of the groove in the extension direction of the groove.

In an embodiment, the second surface includes a first region and a second region surrounding a periphery of the first region; and the plurality of grooves are formed in the first region. an embodiment, a minimum distance between a boundary line of a side that is of the second region and that is away from the first region and a boundary line of the first region is greater than a preset distance. In other words, the plurality of grooves are formed in a central region of the second surface, and no groove is formed in a boundary region surrounding the central region. It should be understood that the foregoing central region is not a geometric center in a strict sense, but a “center” relative to the boundary region. The grooves are formed only in the central region, and flatness of the boundary region is retained, so that mechanical strength of the infrared optical window can be ensured, and the infrared optical window can demonstrate good mounting stability after being mounted at the opening of the sample pool.

In an embodiment, a material of the infrared optical window is high-purity silicon like monocrystalline silicon or polycrystalline silicon.

In an embodiment, a surface-enhanced infrared effect thin film is formed on the first surface. For the first surface deposited with the surface-enhanced infrared effect thin film, an infrared signal of the component that is of the to-be-detected substance and that is adsorbed on the first surface is amplified. For example, the surface-enhanced infrared effect thin film may be a nano gold layer or a nano copper layer. The nano gold layer or the nano copper layer may be formed on a reflective surface of the infrared window by using an electrochemical deposition method or a chemical deposition method. A thickness of the nano gold layer may range from 25 nm to 100 nm, and a thickness of the nano copper layer may range from 25 nm to 100 nm.

In an embodiment, a to-be-detected substance component detection apparatus is an electroplating solution component detection apparatus. The electroplating solution component detection apparatus further includes an electrical signal applicator, where the electrical signal applicator is electrically connected to the surface-enhanced infrared effect thin film, and the electrical signal applicator is configured to apply an electrical signal to the surface-enhanced infrared effect thin film, so that the surface-enhanced infrared effect thin film is used as a working electrode. When the electroplating solution component detection apparatus is used to detect components of a to-be-detected electroplating solution, the electrical signal applicator applies an electrical signal to the surface-enhanced infrared effect thin film. In this way, a component having an electrochemical activity in the to-be-detected electroplating solution is enabled to participate in an electrochemical reaction on the first surface of the infrared optical window, and a reaction product and/or an intermediate product are/is deposited on the first surface. In addition, a component having no electrochemical activity in the to-be-detected electroplating solution may also be adsorbed on the first surface of the infrared optical window. In addition, the infrared light source emits an infrared signal, so that the infrared signal is irradiated on the incident surface of each protruding portion on the second surface of the infrared optical window, and reaches the first surface of the infrared optical window. The detector receives an infrared signal that is reflected by the first surface and that is emitted through the emergent surface of each protruding portion. Finally, a corresponding infrared absorption spectrum is determined based on the infrared signal received by the detector. It can be learned with reference to a structure characteristic of the infrared optical window described in the foregoing implementations that, because an optical path of the infrared signal in the window medium is short, when the infrared signal passes through the window medium, absorption of the infrared signal by the window medium is reduced. In combination with amplification effect of the surface-enhanced infrared effect thin film on the infrared signals of the component adsorbed on the first surface, the detector can receive abundant fingerprint region signals. In this way, a microcomponent of the electroplating solution can be detected. It can be learned that, when the foregoing electroplating solution component detection apparatus is used to detect the components of the electroplating solution, a component having no electrochemical activity can be detected without being affected by polarity strength of the to-be-detected component. In addition, the microcomponent of the electroplating solution can be detected. This shows high sensitivity and resolution.

In an embodiment, the electroplating solution component detection apparatus further includes: a counter electrode, electrically connected to the electrical signal applicator, where the counter electrode is configured to form an electrical loop with the infrared optical window; and a reference electrode, electrically connected to the electrical signal applicator, where the reference electrode is configured to obtain an electric potential of the infrared optical window.

According to a second aspect, a method for detecting a component of a substance by using the substance component detection apparatus provided in the first aspect is provided. The method includes: An infrared light source emits an infrared signal, where the infrared signal is irradiated on an incident surface, and reaches a first surface to be totally reflected; a detector receives the infrared signal reflected by the first surface; and the component of the to-be-detected substance and/or content of the component is determined based on the infrared signal received by the detector.

In an embodiment, a surface-enhanced infrared effect thin film is formed on the first surface, and the surface-enhanced infrared effect thin film is configured to amplify an infrared signal of the component that is of the to-be-detected substance and that is adsorbed on the first surface.

In an embodiment, the substance component detection apparatus is the electroplating solution component detection apparatus provided in the first aspect, and the to-be-detected substance is a to-be-detected electroplating solution. When a component of the to-be-detected electroplating solution and/or content of the component are/is detected, the method includes: An electrical signal applicator applies an electrical signal to the surface-enhanced infrared effect thin film, so that the surface-enhanced infrared effect thin film is used as a working electrode, and an electrochemical reaction occurs on the component of the to-be-detected electroplating solution on the first surface.

In an embodiment, when the component of the to-be-detected electroplating solution and/or the content of the component are/is detected, determining content of a target component of the to-be-detected electroplating solution based on the infrared signal received by the detector includes: obtaining an infrared absorption spectrum of the to-be-detected electroplating solution based on the infrared signal received by the detector; obtaining a characteristic absorption peak area of the target component in the infrared absorption spectrum based on a characteristic absorption peak of the target component in the infrared absorption spectrum; and determining the content of the target component of the electroplating solution based on the characteristic absorption peak area of the target component in the infrared absorption spectrum and a relationship between the content of the target component and the characteristic absorption peak area.

The relationship between the content of the target component and the characteristic absorption peak area may be obtained by performing the following operations.

Operation 1: Prepare standard solutions of the target component at a plurality of concentrations, where the target component is any component of the to-be-detected electroplating solution.

Operation 2: Detect the standard solutions at the plurality of concentrations in sequence by using the electroplating solution component detection apparatus, to obtain infrared absorption spectrums of the standard solutions at the plurality of concentrations.

Operation 3: For the infrared absorption spectrum of the standard solution at each concentration, obtain, based on a characteristic absorption peak of the target component in the infrared absorption spectrum, a characteristic absorption peak area corresponding to the standard solution at each concentration.

Operation 4: Determine the relationship between the concentration of the target component and the characteristic absorption peak area based on the characteristic absorption peak area corresponding to the standard solution at each concentration.

In addition, for technical effect brought by the second aspect, refer to technical effect brought by different designs in the first aspect. Details are not described herein again.

### BRIEF DESCRIPTION OF DRAWINGS

FIG. 1 is a diagram of an example of an electroplating solution component detection apparatus according to this application;

FIG. 2 is a diagram of examples of a semi-cylindrical window and an infrared signal transmission path according to this application;

FIG. 3 is a diagram of examples of a prismatic window and an infrared signal path according to this application;

FIG. 4 is a diagram of an example of a cross-section of an infrared optical window according to this application;

FIG. 5 is a diagram of an example of a transmission path of an infrared signal in an infrared optical window medium shown in FIG. 4 according to this application;

FIG. 6 is a diagram of an example of a second surface of an infrared optical window according to this application;

FIG. 7 is a diagram of an example of another second surface of an infrared optical window according to this application;

FIG. 8 is a diagram of an example of another cross-section of an infrared optical window according to this application;

FIG. 9 is a diagram of an example of a substance component detection apparatus according to this application;

FIG. 10 is an infrared absorption spectrogram of an additive A obtained in Embodiment 1;

FIG. 11 is an infrared absorption spectrogram of an additive B obtained in Embodiment 2;

FIG. 12 is an infrared absorption spectrum obtained in Embodiment 3 and a curve diagram that is of a relationship between a concentration of an additive A within a range of 15 ppb to 120 ppb and a characteristic peak area and that is obtained in Embodiment 3;

FIG. 13 is a curve diagram that is of a relationship between a concentration of an additive A and a characteristic peak area and that is obtained in Embodiment 4; and

FIG. 14 is an infrared absorption spectrogram obtained in Comparative Example 1.

### DESCRIPTION OF EMBODIMENTS

The following describes the technical solutions in embodiments of this application with reference to the accompanying drawings in embodiments of this application. It is clear that the described embodiments are merely some but not all of embodiments of this application.

The following describes technical terms used in embodiments of this application.

Infrared spectrum analysis: The infrared spectrum analysis means analysis and identification performed on a substance molecule based on an infrared absorption spectrum. For example, a beam of infrared rays with different wavelengths is irradiated on a molecule of a substance, and some infrared rays with specific wavelengths are absorbed to form an infrared absorption spectrum of the molecule.

Infrared absorption spectrum: The infrared absorption spectrum is a vibration pattern generated due to continuous vibration and rotation of a molecule. Molecular vibration means that atoms in a molecule move relatively near an equilibrium position. A multi-atomic molecule may form a plurality of vibration patterns. Energy of the molecule vibration exactly corresponds to optical quantum energy of infrared rays. Therefore, when a vibration status of the molecule changes, the infrared spectrum may be transmitted, or the infrared absorption spectrum may be generated because the molecule is triggered by infrared radiation to vibrate.

Infrared optical window: The infrared optical window is an optical window through which an infrared signal may pass. In addition, the infrared optical window can further isolate a to-be-detected sample from an infrared light source. For example, the infrared light source and the to-be-detected sample are respectively located on two sides of the infrared optical window, and an infrared signal sent by the infrared light source passes through the infrared optical window and is irradiated on the to-be-detected sample.

Working electrode: The working electrode is an electrode, in an electrolytic system, that can cause an obvious change to a concentration of a to-be-detected component of a to-be-detected solution. The working electrode and a counter electrode form a loop, to form an electrolytic system for a to-be-detected solution.

Reference electrode: The reference electrode is an electrode used as a reference for comparison when various electrode potentials are measured. A to-be-measured electrode and a reference electrode with an accurately known electrode potential value form a battery. An electrode potential of the to-be-measured electrode can be calculated by measuring an electromotive force value of the battery. In the foregoing electrolytic system, the reference electrode is used to obtain an electric potential value of the working electrode.

Mercurous sulfate electrode: The mercurous sulfate electrode is a reference electrode.

Infrared spectrum fingerprint region: The infrared spectrum fingerprint region means an infrared signal whose wave number ranges from 1300 cm⁻¹ to 400 cm⁻¹. An absorption peak in the infrared spectrum fingerprint region has a strong characteristic, and may be used to distinguish slight differences in structures of different compounds.

Electroplating: The electroplating is a process of plating another metal plated layer or alloy plated layer on some metal or non-metallic surfaces based on an electrolytic principle. Another metal plated layer or alloy plated layer is plated on a surface of metal or a surface of a non-metal product, so that metal oxidation (for example, rusting) can be prevented, wear resistance, conductivity, light reflection, and corrosion resistance (for example, copper sulfate) can be improved, and aesthetics can be improved.

Electroplating solution: The electroplating solution is a liquid that is used in an electroplating process and that may expand a cathode current density range of metal, improve an appearance of a plated layer, and increase features such as antioxidant stability of a solution. The electroplating solution usually includes: a main salt (a salt containing deposited metal and providing an ion of electrodeposited metal, where the main salt exists in different electroplating solutions in a form of a complexation ion or a hydrated ion, and a higher concentration of the main salt indicates higher current efficiency, a faster deposition speed of metal, a coarse grain of a plated layer, and a decreased dispersion capability of the solution), a conducting salt (used to increase a conducting capability of the solution, to expand an allowed current density range), an anode active agent (a substance that can promote dissolution at an anode and increase a current density at the anode, to ensure that the anode is in an activated state and can dissolve normally), a buffer agent (a substance used to adjust and control pH of the solution), and an additive (for example, a leveling agent, a brightener, or an anti-pitting agent that can improve performance and electroplating quality of a plated layer, where the brightener is mainly used to increase light brightness of the plated layer, a wetting agent is used to increase interface tension between metal and the solution, the leveling agent can change micro flatness of a metal surface, and a stress relieving agent can reduce an internal stress of the plated layer and improve toughness of the plated layer). It should be noted that not all electroplating solutions have to contain the foregoing various components except for the main salt and the conducting salt.

Unless otherwise defined, all technical terms used herein have the same meaning as those commonly known to a person of ordinary skill in the art. In this application, “at least one (layer)” means one (layer) or more (layers), and “a plurality of (layers)” means two (layers) or more (layers). “And/or” describes an association relationship between associated objects, and represents that three relationships may exist. For example, A and/or B may represent the following cases: Only A exists, both A and B exist, and only B exists, where A and B may be singular or plural. The character “/” generally indicates an “or” relationship between associated objects. “At least one item (piece) of the following” or a similar expression thereof means any combination of these items, including a singular item (piece) or any combination of plural items (pieces). For example, at least one item (piece) of a, b, or c may represent: a, b, c, a and b, a and c, b and c, or a, b, and c, where a, b, and c may be singular or plural. In addition, in embodiments of this application, terms such as “first” and “second” do not limit a quantity and a sequence.

In addition, in this application, position terms such as “upper”, and “lower” are defined relative to schematic positions of components in the accompanying drawings. It should be understood that these direction terms are relative concepts and are used for relative description and clarification, and may change accordingly as positions at which the components in the accompanying drawings are placed change.

It should be noted that in this application, the term like “example” or “for example” represents giving an example, an illustration, or a description. Any embodiment or design scheme described as an “example” or “for example” in this application should not be explained as being more preferred or having more advantages than another embodiment or design scheme. Exactly, use of the word like “example” or “for example” is intended to present a related concept in a specific manner.

The technical solutions provided in this application may be applied to any scenario in which a to-be-detected component may be analyzed by using an infrared absorption spectrum technology, for example, the food field, the pharmaceutical field, the agricultural technology field, the organic polymer field, and the electroplating process technology field mentioned in the foregoing content.

Microelectronic electroplating is an electroplating process branch obtained through division based on an application scenario. Generally, a purpose of the microelectronic electroplating is to form a metal layer with a function, for example, a conducting layer or a thin film electrode, on a microelectronic device. Alternatively, the microelectronic electroplating is performed to improve solderability of the microelectronic device. For this purpose, a plated layer electroplated onto the device is usually a solderable plated layer, for example, a gold, silver, tin, tin-lead alloy, tin-copper-silver alloy, tin-cerium alloy, or tin-bismuth alloy plated layer. It is easy to understand that, regardless of an electroplating purpose, constant content of components of an electroplating solution used for electroplating is an important control target, to ensure that an obtained plated layer has an expected property and form.

Therefore, it is important to use a detection and analysis method to perform detection and content analysis on the components of the electroplating solution periodically or in real time.

High performance liquid chromatography (HPLC) and cyclic voltammetry stripping (CVS) are commonly used electroplating solution component detection methods. In the high performance liquid chromatography method, a high-voltage infusion system is used, and an electroplating solution sample is used as a mobile phase to be pumped into a chromatographic column equipped with a stationary phase. In the column, components of the electroplating solution are separated. Then, a detector is used for detection. In this way, analysis on the components of the electroplating solution is implemented. Therefore, the high performance liquid chromatography method requires that a polarity difference between to-be-analyzed substance components should be large and that the to-be-analyzed substance components should be reversibly adsorbed by the chromatographic column. In other words, a component irreversibly adsorbed by the chromatographic column cannot be detected by using the high performance liquid chromatography method, that is, detection sensitivity for a component of this type is low. In addition, it is also difficult to analyze and identify components with similar polarities by using the high performance liquid chromatography method, that is, resolution for some components is low. The cyclic voltammetry stripping method is a branch of cyclic voltammetry (CV). However, the cyclic voltammetry stripping method requires that a to-be-analyzed substance component should have a strong electrochemical activity and can generate a strong electrochemical signal on an electrode surface. Therefore, low sensitivity and resolution are shown for a substance component with an extremely small additive amount or without electrochemical activity, and even the substance component with an extremely small additive amount or without electrochemical activity cannot be detected at all.

Therefore, it is considered to use the infrared absorption spectrum technology to perform detection and content analysis on the components of the electroplating solution. In practical application of analyzing to-be-detected components by using the infrared absorption spectrum technology, an infrared signal emitted by an infrared light source needs to be irradiated on a to-be-detected substance through an infrared optical window. However, it is easy to understand that, regardless of a specific material (referred to as a window medium below for short) used by the infrared optical window, when passing through the window medium, the infrared signal is partially absorbed by the window medium, and then the infrared signal is attenuated. This definitely affects accuracy of an infrared absorption spectrum of the to-be-detected substance. It is easy to understand that a longer optical path of the infrared signal in the window medium indicates more serious absorption of the infrared signal by the window medium, and more serious attenuation of the infrared signal.

A method for analyzing a to-be-detected component by using an infrared absorption spectrum technology includes a detection method based on total reflection of an infrared signal. It should be noted that, in the detection method based on total reflection of an infrared signal, when passing through the window medium, an infrared signal emitted by an infrared light source is partially absorbed by a window medium, and this causes signal attenuation. In addition, when passing through the window medium, a reflected signal corresponding to the infrared signal is also partially absorbed by the window medium, and this causes signal attenuation again. In other words, the signal attenuation generated on a transmission path of the infrared signal has extremely serious effect on the accuracy of the infrared absorption spectrum of the to-be-detected substance. Due to the effect of signal attenuation, it is extremely likely that a to-be-detected component with low content cannot be detected.

Based on this, this application provides an electroplating solution component detection apparatus. In the apparatus, a surface-enhanced infrared effect thin film formed on a first surface of an infrared optical window is used as a working electrode. When an electrical signal is applied to the surface-enhanced infrared effect thin film, an electrolytic system including the surface-enhanced infrared effect thin film and a to-be-detected electroplating solution is to be formed, so that a component having an electrochemical activity in the electroplating solution participates in an electrochemical reaction on the first surface of the infrared optical window, and a reaction product and/or an intermediate product is deposited on the first surface. In addition, a component having no electrochemical activity in the electroplating solution may also be adsorbed on the first surface of the infrared optical window. The first surface is a surface of a side that is of the infrared optical window and that is in contact with the to-be-detected electroplating solution. In addition, based on a special structure characteristic of the infrared optical window, an optical path of an infrared signal in a window medium can be shortened, so that absorption of the infrared signal by the window medium is reduced. In combination with a function of the surface-enhanced infrared effect thin film, the detector can detect an infrared signal with a wider band. In this way, a high detection sensitivity is shown.

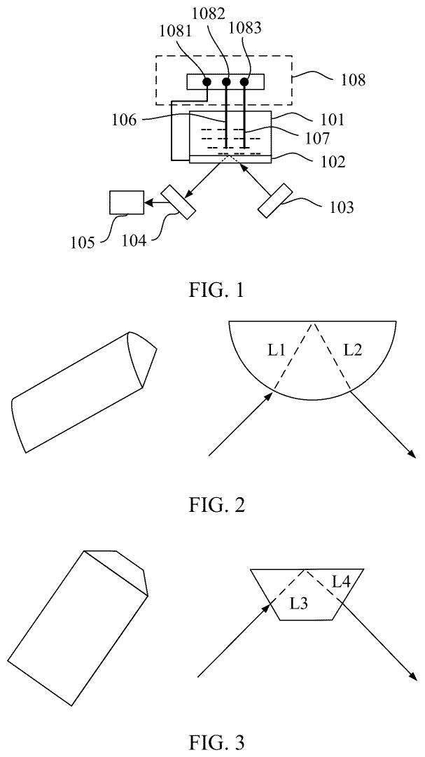

FIG. 1 is a diagram of an example of an electroplating solution component detection apparatus according to this application. As shown in FIG. 1, the electroplating solution component detection apparatus includes a sample pool 101, an infrared optical window 102, an infrared light source 103, a detector 104, a signal processing unit 105, a counter electrode 106, a reference electrode 107, and an electrical signal applicator 108.

The sample pool 101 is configured to accommodate a to-be-detected electroplating solution.

The sample pool 101 has two openings. One of the two openings is used as a channel for injecting the to-be-detected electroplating solution, for example, an exposure on a top of the sample pool 101 in the example shown in FIG. 1. An embodiment, a detachable sealing plate may be mounted at the opening. The detachable sealing plate can be used to determine, based on a test requirement, whether to seal space in the sample pool, to prevent the to-be-detected electroplating solution from leaking.

The infrared optical window 102 is mounted at the other opening of the sample pool 101, so that the infrared optical window 102 becomes a part of the complete sample pool 101. For example, in the example shown in FIG. 1, the infrared optical window 102 is mounted at an opening at a bottom of the sample pool 101. In this way, a surface that is of the infrared optical window and that faces an inner side of the sample pool 101 can be in contact with a to-be-detected substance, and a surface that is of the infrared optical window and that is exposed on an outer side of the sample pool 101 is used as an incident surface and an emergent surface of an infrared signal. The incident surface herein may be understood as a surface on which an infrared signal emitted by the infrared light source 103 may be irradiated. In other words, when the infrared light source 103 emits an infrared signal for detecting a component, the incident surface herein is a surface on which an incident point of the infrared signal on the infrared optical window 102 is located. The emergent surface herein may be understood as a surface through which an infrared signal reflected by the surface that is of the infrared optical window and that faces the inner side of the sample pool 101 passes when being emitted from a window medium. For ease of description, in the following embodiment, the surface that is of the infrared optical window 102 and that faces the inner side of the sample pool 101 is referred to as a first surface, and the surface that is of the infrared optical window 102 and that is exposed on the outer side of the sample pool 101 is referred to as a second surface.

A surface-enhanced infrared effect thin film is formed on the first surface of the infrared optical window 102, and the surface-enhanced infrared effect thin film is configured to amplify an infrared signal of the component that is of the to-be-detected substance and that is adsorbed on the first surface. The surface-enhanced infrared effect thin film is specifically a metal thin film. For example, the surface-enhanced infrared effect thin film may be a nano gold layer or a nano copper layer. The nano gold layer or the nano copper layer may be formed on a reflective surface of the infrared window by using an electrochemical deposition method or a chemical deposition method. A thickness of the nano gold layer may range from 25 nm to 100 nm, and a thickness of the nano copper layer may range from 25 nm to 100 nm.

It should be noted that a three-dimensional shape of the sample pool 101 is not limited to a cuboid shape shown in FIG. 1. For example, the three-dimensional shape of the sample pool 101 may alternatively be a cylindrical shape or a prismatic shape. In addition, the two openings of the sample pool are not limited to being opened at positions shown in FIG. 2. For example, the openings may alternatively be opened on a side wall of the sample pool 101. In this case, the infrared optical window 102 is mounted on the side wall of the sample pool.

The infrared light source 103 is configured to emit an infrared signal, and the detector 104 is configured to receive the infrared signal reflected by the first surface. An embodiment, the detector 104 may be a photoconductive detector.

The signal processing unit 105 is configured to perform conversion processing (for example, Fourier transform processing) on an infrared signal detected by the detector 104, to obtain a corresponding infrared absorption spectrum.

The electrical signal applicator 108 has a first interface 1081, a second interface 1082, and a third interface 1083. The surface-enhanced infrared effect thin film is electrically connected to the electrical signal applicator 108 through the first interface 1081, and is configured to be used as a working electrode. The counter electrode 106 is electrically connected to the electrical signal applicator 108 through the second interface 1082, and is configured to form an electrical loop with the working electrode. The reference electrode 107 is electrically connected to the electrical signal applicator 108 through the third interface 1083, and is configured to obtain an electrical potential value of the working electrode. It should be noted that a disposing position of each component in the foregoing detection apparatus is not limited in this application. Actually, the foregoing detection apparatus may further include one or more optical devices, for example, a reflection lens, configured to change a transmission direction of an infrared signal. Theoretically, such an optical device is disposed, so that an infrared signal emitted by the infrared light source in any direction can finally be irradiated on the incident surface of the infrared optical window. Similarly, a reflected signal in any direction can finally be received by the detector. It can be learned that such an optical device is disposed, so that disposing positions of the infrared light source 103 and the detector 104 can be more flexible, and the foregoing detection apparatus can have better integration ability.

In some embodiments, the foregoing detection apparatus further includes a console. The console is connected to the infrared light source 103, the detector 104, and the signal processing unit 105, and is configured to control the infrared light source 103, the detector 104, and the signal processing unit 105.

In some other embodiments, the signal processing unit 105 may be integrated into the detector 104, so that the detector 104 has a function of the signal processing unit 105. Alternatively, the signal processing unit 105 may be integrated into the console, so that the console has a function of the signal processing unit 105. This is not limited herein. When the foregoing electroplating solution component detection apparatus is used to detect a component of the to-be-detected electroplating solution, the electrical signal applicator 108 applies an electrical signal to the surface-enhanced infrared effect thin film on the first surface of the infrared optical window 102, so that the surface-enhanced infrared effect thin film is used as a working electrode, to form an electrolytic system including the working electrode and the to-be-detected electroplating solution. In this way, a component having an electrochemical activity in the to-be-detected electroplating solution is enabled to participate in an electrochemical reaction on the first surface of the infrared optical window 102, and a reaction product and/or an intermediate product are/is deposited on the first surface. In addition, a component having no electrochemical activity in the to-be-detected electroplating solution may also be adsorbed on the first surface of the working electrode.

In addition, the infrared light source 103 emits an infrared signal, so that the infrared signal passes through the infrared optical window medium, and reaches the first surface of the infrared optical window 102. The detector 104 receives the infrared signal reflected by the first surface. Finally, content of the component of the to-be-detected electroplating solution is determined based on the infrared signal received by the detector 104.

Conventional infrared optical windows include a semi-cylindrical window and a prismatic window. Before the infrared optical window used in this application is described, the following first describes the semi-cylindrical window and the prismatic window, including descriptions of mounting manners of the two windows with reference to the detection apparatus in FIG. 1, and descriptions of a transmission path of an infrared signal in a window medium based on the mounting manner. However, this does not mean that the detection apparatus provided in this application uses the two windows. It should be emphasized that the detection apparatus provided in this application uses an infrared optical window that has a special structure characteristic.

FIG. 2 is a diagram of examples of a semi-cylindrical window and an infrared signal transmission path according to this application. As shown in FIG. 2, the semi-cylindrical window includes two opposite semi-circular bottom surfaces and two side surfaces. One of the two side surfaces is a curved surface, and the other is a plane. Herein, the plane is referred to as a first side surface, and the curved surface is referred to as a second side surface. If the semi-cylindrical window is mounted in the sample pool 101 shown in FIG. 1, the first side surface is equivalent to the first surface, and is configured to be in contact with the to-be-detected substance; and the second side surface is equivalent to the second surface, and is configured to be used as the incident surface and the emergent surface of the infrared signal. As shown in FIG. 2, the infrared signal reaches the second side surface through the first side surface, and a reflected signal on the second side surface returns to the first side surface, and is emitted through the first side surface. In this example, an optical path of the infrared signal in a window medium may be represented as L1+L2.

FIG. 3 is a diagram of examples of a prismatic window and an infrared signal path according to this application. As shown in FIG. 3, the prismatic window includes two opposite trapezoidal bottom surfaces, two opposite and parallel side surfaces, and another two opposite but unparallel side surfaces. For ease of description, the another two opposite but unparallel side faces herein are referred to as a third side surface and a fourth side surface. If the prismatic window is mounted in the sample pool 101 shown in FIG. 1, a bottom surface with a larger area of the prismatic window is equivalent to the first surface, and is configured to be in contact with the to-be-detected substance; and the third side surface and the fourth side surface are equivalent to the second surface, where the third side surface may be used as the incident surface of the infrared signal, and the fourth side surface may be used as the emergent surface of the infrared signal. As shown in FIG. 3, the infrared signal reaches the bottom surface with a larger area through the third side surface, and a reflected signal on the bottom surface is emitted to the fourth side surface, and is emitted through the fourth side surface. In this example, an optical path of the infrared signal in a window medium may be represented as L3+L4.

According to the technical solutions provided in this application, an infrared optical window whose structure is different from that of the semi-cylindrical window and that of the prismatic window is used. The infrared optical window enables the optical path of the infrared signal in the window medium to be shortened, so that absorption of the infrared signal by the window medium is reduced, and the detector can detect an infrared signal with a wider band. In this way, a high detection sensitivity is shown.

For example, a plurality of grooves are formed on the second surface of the infrared optical window 102 provided in this embodiment of this application, and there is a spacing between two adjacent grooves, to form a protruding portion. Any protruding portion has two opposite side surfaces and a top surface located between the two side surfaces, where one of the two side surfaces is used as an incident surface of the infrared signal, and the other side surface is used as the emergent surface of the infrared signal. It should be understood that a specific side surface that is of the protruding portion and that is used as the incident surface and a specific side surface that is of the protruding portion and that is used as the emergent surface depend on an incident direction of the infrared signal. An infrared signal emitted by the infrared light source 103 may be irradiated to the incident surface and reaches the first surface. A reflected signal of the infrared signal on the first surface may leave the window medium through the emergent surface, to be received by the detector 104. The plurality of grooves are formed on the second surface. This is equivalent to reducing thicknesses of a plurality of regions on the infrared optical window 102. Therefore, an optical path of the infrared signal passing through the window medium is shortened, and absorption of the infrared signal by the window medium is reduced, so that the detector can receive abundant fingerprint region signals, and a detection lower limit (namely, a minimum concentration that can be detected) for content of a component of the to-be-detected substance is reduced. This shows high sensitivity.

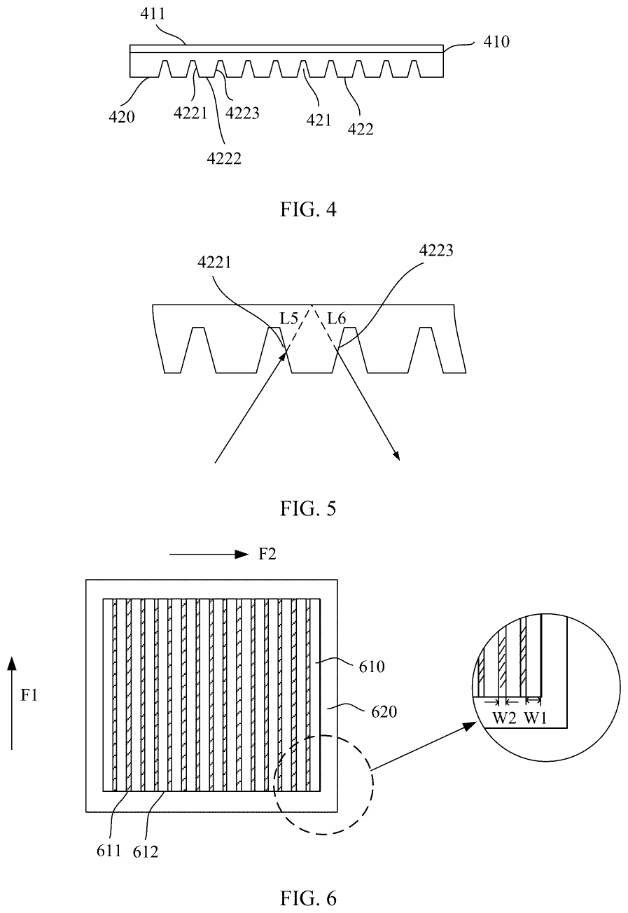

FIG. 4 is a diagram of an example of a cross-section of the infrared optical window 102 according to this application. The cross-section is specifically a cross-section in a direction perpendicular to a first surface (and a second surface) of the infrared optical window 102. As shown in FIG. 4, the infrared optical window includes a first surface 410 and a second surface 420. A surface-enhanced infrared effect thin film 411 is formed on the first surface 410, and the thin film may amplify an infrared signal of a component that is of a to-be-detected substance and that is adsorbed on the first surface. The foregoing surface-enhanced infrared effect thin film may be a nano gold layer or a nano copper layer. When the surface-enhanced infrared effect thin film is formed on the first surface, polishing processing is first performed on the first surface, and then the surface-enhanced infrared effect thin film is formed on the first surface by using an electrochemical deposition method or a chemical deposition method. A plurality of grooves 421 are formed on the second surface 420, and there is a spacing between any two adjacent grooves 421. In this way, a protruding portion 422 is formed between every two adjacent grooves. Any protruding portion 422 has a side surface 4221, a top surface 4222, and a side surface 4223.

FIG. 5 is a diagram of a transmission path of an infrared signal in a medium of the infrared optical window 102 shown in FIG. 4. Refer to FIG. 5. Based on an incident direction of the infrared signal, for any protruding portion 422, the side surface 4221 of the protruding portion 422 is an incident surface of the infrared signal, and the side surface 4223 of the protruding portion 422 is an emergent surface of the infrared signal. The infrared signal is incident to the window medium from the side surface 4221 of each protruding portion 422, and reaches the first surface. The infrared signal reflected on the first surface is emitted from the window medium through the side surface 4223 of each protruding portion 422. In this example, an optical path of the infrared signal in the window medium may be represented as L5+L6.

The infrared signal is incident to the window medium through one side surface of the protruding portion on the second surface, and the reflected signal of the infrared signal is emitted through the other side surface of the protruding portion. Therefore, a propagation distance of the infrared signal in the window medium is shortened, that is, an optical path of the infrared signal in the window medium is shortened. With reference to FIG. 2, FIG. 3, and FIG. 5, L5+L6<L1+L2, and L5+L6<L3+L4.

In some embodiments, the plurality of grooves are all strip-shaped grooves, for example, trapezoidal grooves or triangular grooves, and extend in a same direction. This groove structure design means that the protruding portions are also strip-shaped and extend in a same direction, and further means that two opposite side surfaces of each protruding portion are also strip-shaped, that is, an incident surface and an emergent surface of an infrared signal are strip-shaped and extend in a same direction. Extension directions of the foregoing three are the same. It should be understood that the strip-shaped incident surface can greatly increase a light receiving area, so that more infrared signals can be irradiated on the component of the to-be-detected substance. In addition, a plurality of strip-shaped incident surfaces extend in a same direction, so that identity of requirements of the plurality of strip-shaped incident surfaces on an infrared signal transmission direction can be ensured, and the strip-shaped incident surfaces are ensured to have same effective light receiving areas. Further, effective light receiving areas of the plurality of strip-shaped incident surfaces can be simultaneously adjusted by adjusting the direction in which the infrared light source emits the infrared signal.

In some embodiments, the plurality of strip-shaped grooves are distributed in an array in a direction perpendicular to the extension direction of the plurality of strip-shaped grooves. This strip-shaped groove distribution design means that spacings between any two adjacent strip-shaped grooves are equal, and there is no excessively large spacing or excessively small spacing. In this way, a case in which an excessively small spacing affects mechanical strength of the infrared optical window or a case in which an excessively large spacing leads to a waste of a region on the second surface and a decrease in a quantity of strip-shaped grooves that can be formed, and further affects implementation of technical effect of shortening an optical path are avoided.

In some embodiments, a cross-section of the groove in a direction perpendicular to the second surface is trapezoidal or triangular, and included angles between the second surface and both the incident surface and the emergent surface that are opposite to each other on the protruding portion are both acute angles. In this way, an effective light receiving area of the incident surface is larger. Further, a cross section of the groove in a direction perpendicular to the second surface may be specifically an isosceles trapezoid or an isosceles triangle.

In some embodiments, the second surface of the infrared optical window includes a first region and a second region surrounding a periphery of the first region; and the plurality of grooves are formed in the first region. In other words, the plurality of grooves are formed in a central region of the second surface, and no groove is formed in a boundary region surrounding the central region. It should be understood that the foregoing central region is not a geometric center in a strict sense, but a “center” relative to the boundary region. An embodiment, a minimum distance between an edge of a side that is of the second region and that is away from the first region and an edge of the first region is greater than a preset distance. In these embodiments, the grooves are formed only in the central region, and flatness of the boundary region is retained, so that mechanical strength of the infrared optical window is ensured, and the infrared optical window can demonstrate good mounting stability after being mounted at the opening of the sample pool 101.

In some other embodiments with reference to the foregoing embodiments, both ends of each strip-shaped groove extend to the edge of the first region, so that a length of the strip-shaped groove in the extension direction of the strip-shaped groove is maximized, and further, a length of the protruding portion in an extension direction of the protruding portion is maximized. That is, a light receiving area of the incident surface on the protruding portion and a light emitting area of the emergent surface on the protruding portion are maximized, where the light receiving area of the incident surface and the light emitting area of the emergent surface are opposite to each other.

FIG. 6 is a diagram of an example of a second surface of an infrared optical window 102 according to this application. As shown in FIG. 6, the second surface includes a first region 610 and a second region 620 surrounding the first region 610. The second region 620 is flat and smooth. In the first region 610, a plurality of strip-shaped grooves 611 of a same size are formed, and the plurality of strip-shaped grooves 611 all extend in a first direction F1 to an edge of the first region, and are distributed in an array in a second direction F2 perpendicular to the first direction F1. Because there is an equal spacing between every two adjacent strip-shaped grooves 611, a plurality of strip-shaped protruding portions 612 of a same size are formed. The plurality of strip-shaped protruding portions 612 all extend in the first direction F1, and are distributed in an array in the second direction F2.

Refer to FIG. 6. It may be understood as the following: A surface mentioned in this application is an outer side surface of a solid/object. For example, the first surface and the second surface of the infrared optical window are two outer side surfaces of a high-purity silicon wafer. A region mentioned in this application is a part of the surface, namely, a partial surface. It should be noted that the surface mentioned in this application is not limited to a two-dimensional plane. For example, the surface may be uneven, or a protruding portion or a concave surface is disposed on the surface. For example, the second surface has a plurality of grooves and protrusions. Correspondingly, as a part of the surface, the region and the surface may be concepts in a same dimension or at a same level. For the infrared optical window 102 shown in FIG. 6, a size of the infrared optical window 102 in the first direction F1 ranges from 2 mm to 11 mm, and a size of the infrared optical window 102 in the second direction F2 ranges from 2 mm to 11 mm. A top width (W2 shown in FIG. 6) of each groove 611 ranges from 0.01 mm to 0.2 mm. The top width of the groove 611 herein may be understood as a width of a top opening of the groove 611, or understood as a span of a groove in the second direction F2. In addition, a top width (W1 shown in FIG. 6) of each protruding portion 612 ranges from 0.1 mm to 0.4 mm, and the top width of the protruding portion 612 herein may be understood as a spacing between two adjacent grooves. In addition, a length of each groove 611 ranges from 2 mm to 10 mm, and the length of the groove 611 herein may be understood as an extension distance of the groove 611 in the first direction F1.

For the infrared optical window 102 shown in FIG. 6, a ratio of the top width of the protruding portion 612 to the top width of the groove 611 is 0.5 to 40. The ratio is designed within a proper range, so that an excessively wide groove or an excessively large spacing between grooves can be avoided. Further, a case in which the excessively wide groove is unfavorable to mechanical strength of the infrared optical window or a case in which the excessively large spacing leads to a waste of a region on the second surface and a decrease in a quantity of grooves that can be formed is avoided.

It should be noted that a shape of the second surface of the infrared optical window 102 is not limited to a rectangle shown in FIG. 6. For example, the shape of the second surface of the infrared optical window 102 may be a circle, an ellipse, or a polygon. Similarly, a shape of the first region on the second surface is not limited to the rectangle shown in FIG. 6, and a shape of the second region is not limited to a regular ring shape shown in FIG. 6. This is not limited in this application.

In some embodiments, a plurality of groove arrays are formed on the second surface of the infrared optical window 102. A groove array may be understood as a group of strip-shaped grooves. The group of strip-shaped grooves extend in a same direction, and are distributed in an array in a direction perpendicular to the extension direction of the group of strip-shaped grooves. The plurality of strip-shaped grooves shown in FIG. 6 may be considered as a groove array. Extension directions corresponding to any two of the plurality of groove arrays may be the same or may be different.

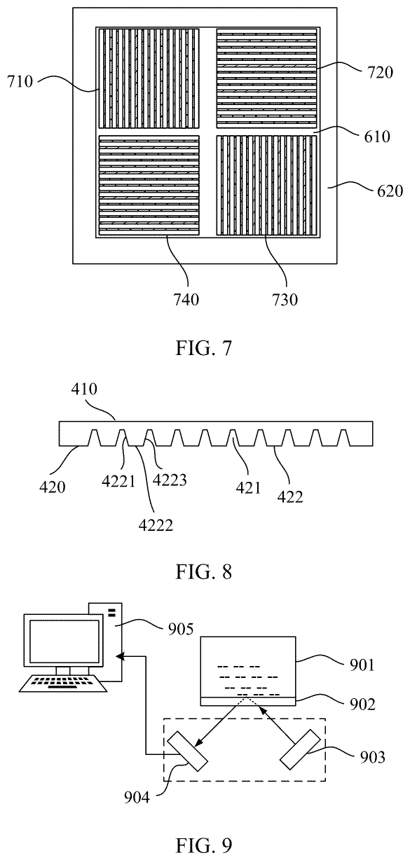

FIG. 7 is a diagram of an example of another second surface of an infrared optical window 102 according to this application. As shown in FIG. 7, the second surface includes a first region 610 and a second region 620 surrounding the first region 610. The second region 620 is flat and smooth. In the first region 610, four groove arrays are formed, and are respectively marked as 710, 720, 730, and 740. For a structure design of each groove array, refer to the plurality of strip-shaped grooves shown in FIG. 6. Details are not described herein.

It should be understood that the foregoing embodiments are merely example embodiments of the infrared optical window shown in this application, and do not constitute a limitation on the infrared optical window provided in this application, and in particular, do not constitute a limitation on a shape, a size, and a distribution manner of the foregoing groove. Other implementation cases obtained based on an inventive concept of “achieving, by forming a surface groove (or referred to as a surface concave, a surface defect, or the like) on an infrared optical window, technical effect of shortening an optical path of an infrared signal in a window medium” in this application all fall within the protection scope of the technical solutions of this application.

In some embodiments, a material of the infrared optical window 102 is high-purity silicon (for example, monocrystalline silicon or polycrystalline silicon), silicon dioxide, a germanium material, or the like.

An example process of preparing the infrared optical window 102 may include: first obtaining a sheet-like high-purity silicon substrate, where a thickness of the sheet-like high-purity silicon substrate may range from 100 μm to 1000 μm; and then, etching, for 30 min to 300 min at 25° C. to 90° C., a surface of the high-purity silicon substrate by using a potassium hydroxide solution with a concentration of 30% to 80%, to obtain the infrared optical window 102 shown in FIG. 6.

Another example process of preparing the infrared optical window 102 may include: first obtaining a sheet-like high-purity silicon substrate, where a thickness of the sheet-like high-purity silicon substrate may range from 400 μm to 700 μm; and then, etching, for 60 min to 120 min at 40° C. to 60° C., a surface of the high-purity silicon substrate by using a potassium hydroxide solution with a concentration of 40% to 60%, to obtain the infrared optical window 102 shown in FIG. 6.

It should be noted that a process method for preparing the infrared optical window 102 is not limited in this application. To obtain the infrared optical window having the foregoing structure characteristic, a person skilled in the art may select, based on different materials of the infrared optical window 102, an appropriate infrared optical window preparation process from well-known process methods without paying creative efforts.

FIG. 8 is a diagram of an example of another cross-section of the infrared optical window 102 according to this application. The cross-section is specifically a cross-section in a direction perpendicular to a first surface (and a second surface) of the infrared optical window 102. Different from the infrared optical window 102 shown in FIG. 4, the infrared optical window 102 shown in FIG. 8 has no surface-enhanced infrared effect thin film formed on the first surface of the infrared optical window 102.

As described above, the technical solutions provided in this application may be applied to any scenario in which a to-be-detected component may be analyzed by using an infrared absorption spectrum technology, and are not limited to detecting an electroplating solution component.

Based on this, an embodiment of this application further provides a substance component detection apparatus. The detection apparatus uses the foregoing infrared optical window. Based on a structure characteristic of the infrared optical window, an optical path of an infrared signal in a window medium is shortened, so that absorption of the infrared signal by the window medium is reduced, and the detector can detect an infrared signal with a wider band. In this way, a high detection sensitivity is shown.

FIG. 9 is a diagram of an example of a substance component detection apparatus according to this application. As shown in FIG. 9, the substance component detection apparatus includes a sample pool 901, an infrared optical window 902, an infrared light source 903, a detector 904, and a signal processing unit 905.

The sample pool 101 is configured to accommodate a to-be-detected substance. The to-be-detected substance may be in a liquid state or a gas state, and the to-be-detected substance may include an organic component and/or an inorganic component.

The sample pool 901, the infrared optical window 902, the infrared light source 903, the detector 904, and the signal processing unit 905 in FIG. 9 may all use structures/devices the same as those in FIG. 1. For a mounting relationship between the sample pool 901 and the infrared optical window 902, refer to descriptions in the foregoing embodiment. Details are not described herein. For a connection relationship between the infrared light source 903, the detector 904, and the signal processing unit 905, also refer to the descriptions in the foregoing embodiment. Details are not described herein. It should be noted that the infrared optical window 902 used in this embodiment may be the infrared optical window shown in FIG. 4, or may be the infrared optical window shown in FIG. 8.

With reference to the substance component detection apparatus shown in FIG. 1, an embodiment of this application further provides a substance component detection method. The method includes the following operations.

Operation 101: The infrared light source 103 emits an infrared signal, where the infrared signal is irradiated to the incident surface of the protruding portion on the second surface of the infrared optical window 102, and reaches the first surface of the infrared optical window 102.

Operation 102: The detector 104 receives the infrared signal that is reflected by the first surface of the infrared optical window 102 and that is emitted through the emergent surface of the protruding portion on the second surface.

Operation 103: The signal processing unit 105 determines a component of the to-be-detected substance and/or content of the component based on the infrared signal received by the detector 104.

For example, the signal processing unit 105 obtains an infrared absorption spectrum of the to-be-detected substance based on the infrared signal received by the detector 104, and further determines the component of the to-be-detected substance and/or the content of the component based on the infrared absorption spectrum of the to-be-detected substance.

When the substance component detection apparatus is specifically an electroplating solution component detection apparatus and the to-be-detected substance is an electroplating solution, the substance component detection method further includes the following operations.

Operation 104: The electrical signal applicator 108 applies an electrical signal to the surface-enhanced infrared effect thin film on the first surface of the infrared optical window 102, so that the surface-enhanced infrared effect thin film is used as a working electrode, to form an electrical loop with the counter electrode 106 and the to-be-detected electroplating solution in the sample pool 101, and also form an electrolytic system of the to-be-detected electroplating solution, where an electrochemical reaction is to occur on components of the to-be-detected electroplating solution on the first surface of the infrared optical window 102.

It should be noted that operation 104 may be performed before operation 102.

In some embodiments, operation 103 may specifically include the following operations.

Operation 1031: Obtain an infrared absorption spectrum of the to-be-detected electroplating solution based on the infrared signal received by the detector 104.

Operation 1032: Obtain a characteristic absorption peak area of a target component in the infrared absorption spectrum based on a characteristic absorption peak of the target component in the infrared absorption spectrum of the to-be-detected electroplating solution.

For example, integration calculation is performed, within a specific wavelength range, on the characteristic absorption peak of the target component in the infrared absorption spectrum of the to-be-detected electroplating solution, to obtain the characteristic absorption peak area of the target component in the infrared absorption spectrum.

Operation 1033: Determine the content of the target component of the electroplating solution based on the characteristic absorption peak area of the target component in the infrared absorption spectrum of the to-be-detected electroplating solution and a relationship between the content of the target component and the characteristic absorption peak area.

The relationship between the content of the target component and the characteristic absorption peak area may be obtained by performing the following operations.

Operation 1: Prepare standard solutions of the target component at a plurality of concentrations, where the target component is any component of the to-be-detected electroplating solution.

Operation 2: Detect the standard solutions at the plurality of concentrations in sequence by using the electroplating solution component detection apparatus, to obtain infrared absorption spectrums of the standard solutions at the plurality of concentrations.

Operation 3: For the infrared absorption spectrum of the standard solution at each concentration, obtain, based on a characteristic absorption peak of the target component in the infrared absorption spectrum, a characteristic absorption peak area corresponding to the standard solution at each concentration.

When the foregoing electroplating solution component detection apparatus is used to detect a component of a target component standard solution or the to-be-detected electroplating solution, the electrical signal applicator applies an electrical signal to the surface-enhanced infrared effect thin film on the first surface of the infrared optical window, so that the surface-enhanced infrared effect thin film is used as a working electrode, to form an electrolytic system including the working electrode and the to-be-detected electroplating solution (or a target additive standard solution). In this way, a component having an electrochemical activity in the to-be-detected electroplating solution (or the target additive standard solution) is enabled to participate in an electrochemical reaction on the first surface of the infrared optical window, and a reaction product and/or an intermediate product are/is deposited on the first surface. In addition, a component having no electrochemical activity in the to-be-detected electroplating solution (or the target component standard solution) may also be adsorbed on the first surface of the infrared optical window. In addition, the infrared light source 103 emits an infrared signal, so that the infrared signal is irradiated on the incident surface of each protruding portion on the second surface of the infrared optical window, and reaches the first surface of the infrared optical window. The detector receives an infrared signal that is reflected by the first surface and that is emitted through the emergent surface of each protruding portion. Finally, a corresponding infrared absorption spectrum is determined based on the infrared signal received by the detector.

It can be learned with reference to a structure characteristic of the infrared optical window described in the foregoing embodiments that, because an optical path of the infrared signal in the window medium is short, when the infrared signal passes through the working electrode, absorption of the infrared signal by the working electrode is reduced, so that the infrared signals received by the detector include abundant fingerprint region signals. In this way, a microcomponent of the electroplating solution can be detected. It can be learned that, when the foregoing detection apparatus is used to detect the components of the electroplating solution, a component having no electrochemical activity can be detected without being affected by polarity strength of the to-be-detected component. In addition, the microcomponent of the electroplating solution can be detected. This shows high sensitivity and resolution.

The following describes, with reference to specific embodiments, a method for detecting an electroplating solution component by using the foregoing electroplating solution component detection apparatus. In addition, advantages of the foregoing electroplating solution component detection apparatus are proved with reference to a comparative example.

### Embodiment 1

In Embodiment 1, a to-be-detected sample including an additive A is detected. Test conditions and parameter conditions are shown in Table 1.

TABLE 1

| Working electrode/ | Infrared optical window |
|---|---|
| Infrared optical window | provided in this application |
| Working electrode potential | −0.55 V |
| Reference electrode | Mercurous sulfate electrode |
| Surface-enhanced infrared | Nano copper layer with a thickness of 60 nm |
| effect thin film | |
| To-be-detected sample | Additive A solution (30 ppm) + HCl solution |
| | (60 ppm) |

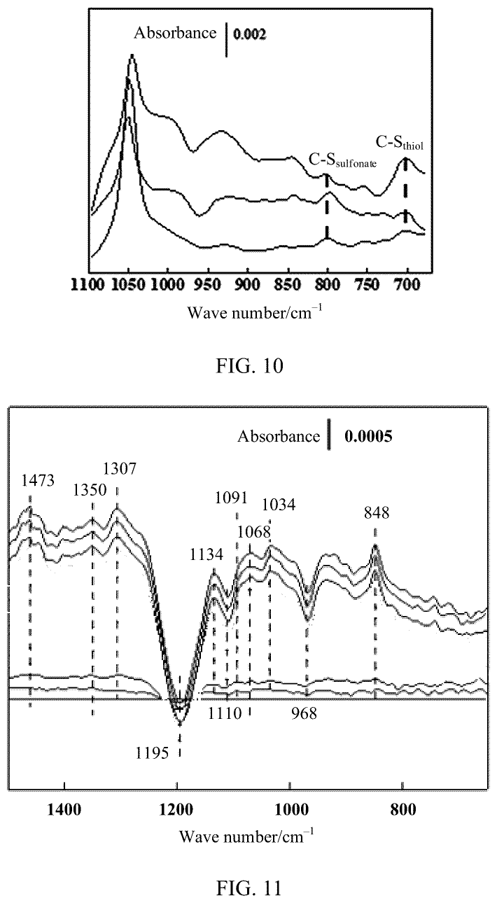

Detection is performed based on the foregoing parameter conditions, to obtain an infrared absorption spectrum shown in FIG. 10. As shown in FIG. 10, an electroplating solution component detection apparatus successfully detects that the additive A has characteristic C—S_{sulfonate} and C—Sₜₕᵢₒₗ absorption in a fingerprint region 650 cm⁻¹ to 1000 cm⁻¹.

It can be learned that the electroplating solution component detection apparatus provided in this embodiment of this application may detect abundant fingerprint region signals, and has high sensitivity.

### Embodiment 2

In Embodiment 2, a to-be-detected sample including an additive B is detected. Test conditions and parameter conditions are shown in Table 2.

TABLE 2

| Working electrode/ | Infrared optical window |
|---|---|
| Infrared optical window | provided in this application |
| Working electrode potential | −0.55 V |
| Reference electrode | Mercurous sulfate electrode |
| Surface-enhanced infrared | Nano copper layer with a thickness of 80 nm |
| effect thin film | |
| To-be-detected sample | Additive B solution (500 ppm) + HCl |
| | solution (60 ppm) |

Detection is performed based on the foregoing parameter conditions, to obtain an infrared absorption spectrum shown in FIG. 11. As shown in FIG. 11, an electroplating solution component detection apparatus successfully detects that the additive B swings within a CH2 surface at 848 cm⁻¹.

### Embodiment 3

In Embodiment 3, a standard curve of an additive A is made. Test conditions and parameter conditions are shown in Table 3.

TABLE 3

| Working electrode/ | Infrared optical window |
|---|---|
| Infrared optical window | provided in this application |
| Working electrode potential | 0.1 V |
| Reference electrode | Mercurous sulfate electrode |
| Surface-enhanced infrared | Nano gold layer with a thickness of 50 nm |
| effect thin film | |
| To-be-detected sample | Additive A standard solution at a plurality |
| | of concentrations + 60 ppm HCl solution |
| Concentration gradient range | 15 ppb to 120 ppb |
| of the additive A | |

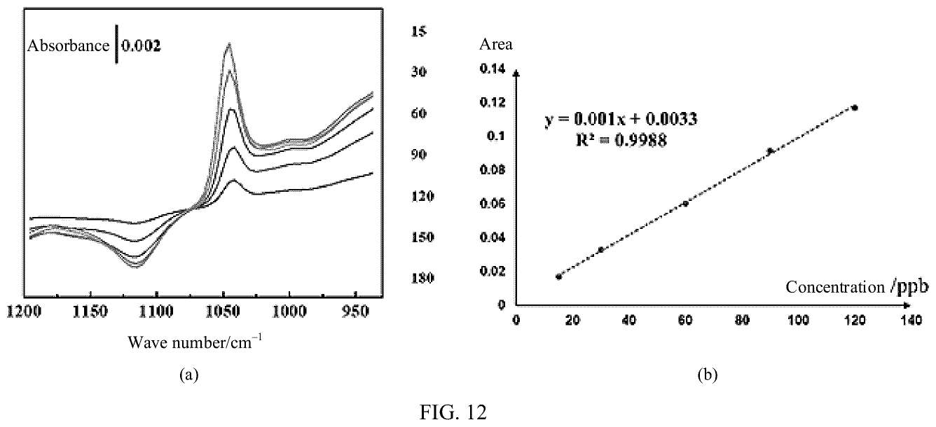

A 60 ppm HCl solution is first added to a sample pool, and then, infrared absorption spectrums of the additive A standard solutions at the foregoing concentrations are sequentially collected, as shown in (a) in FIG. 12. For the infrared absorption spectrums corresponding to the concentrations, characteristic peaks of sulfonate at 1045 cm⁻¹ are integrated, to establish a relationship between peak areas and the concentrations, and obtain a relationship curve between the concentrations of the additive A within a range of 15 ppb to 120 ppb and the characteristic peak areas, as shown in (b) in FIG. 12.

It can be learned that there is a linear correlation between the concentrations of the additive A within the range of 15 ppb to 120 ppb and the characteristic peak areas.

### Embodiment 4

In Embodiment 4, a concentration (represented as X, and actually of 22.5 ppb) of an additive A in an electroplating solution is detected. Test conditions and parameter conditions are shown in Table 4.

TABLE 4

| Working electrode/ | Infrared optical window |
|---|---|
| Infrared optical window | provided in this application |
| Working electrode potential | 0.1 V |
| Reference electrode | Mercurous sulfate electrode |
| Surface-enhanced infrared | Nano gold layer with a thickness of 50 nm |
| effect thin film | |
| To-be-detected sample | Additive A solution at a plurality of |
| | concentrations |
| Concentration gradients | 15 ppb, 30 ppb, 60 ppb, and (X + 60) ppb |
| of the additive A | |

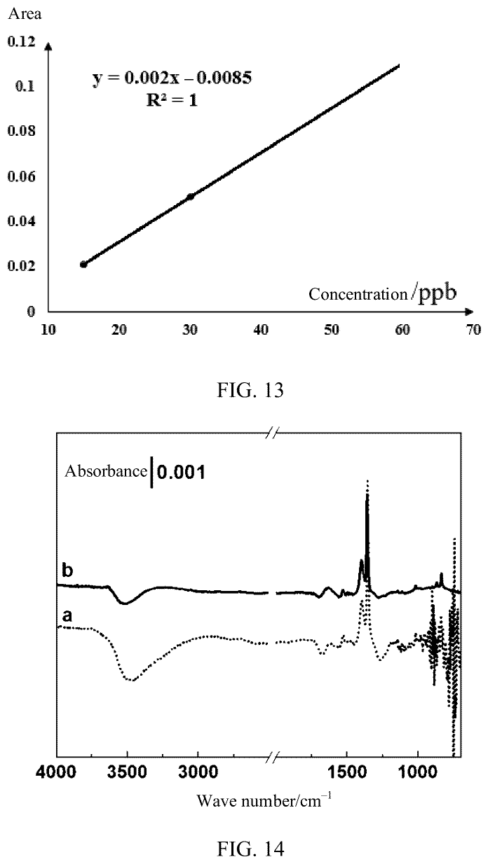

Infrared absorption spectrums of the samples at the foregoing concentrations are sequentially collected. For the infrared absorption spectrums corresponding to the concentrations, characteristic peaks of sulfonate at 1045 cm⁻¹ are integrated, to establish a standard curve between peak areas obtained at concentrations of 15 ppb, 30 ppb, and 60 ppb and the concentrations. As shown in FIG. 13, a standard curve represents a linear relationship between peak areas and additive concentrations. When (X+60) is substituted into the linear relationship represented by the standard curve, that X is 20.3 ppb is obtained.

It can be learned that an error of detecting the concentration of the additive A in the electroplating solution by the electroplating solution component detection apparatus is less than 10%.

### Comparative Example 1

In Comparative Example 1, a conventional semi-cylindrical infrared optical window and the infrared optical window provided in this application are used to detect content of an additive C in a same to-be-detected sample when other test conditions are the same.

Test conditions and parameter conditions in Comparative Example 1 are shown in Table 5.

TABLE 5

| | |
|---|---|
| Working electrode potential | 0.2 V |
| Reference electrode | Mercurous sulfate electrode |
| Surface-enhanced infrared | Gold film with a thickness of 50 nm |
| effect thin film | |
| To-be-detected sample | Additive C solution (400 ppm) |

FIG. 14 is an infrared absorption spectrogram obtained in Comparative Example 1, where a in FIG. 14 represents an infrared absorption spectrum that is of the additive C and that is obtained by using the semi-cylindrical infrared optical window, and b in FIG. 14 represents an infrared absorption spectrum that is of the additive C and that is obtained by using the infrared optical window provided in this application. It can be learned that when the content of the additive C is measured by using a semi-cylindrical high-purity silicon cylinder as the infrared optical window, a large amount of noise occurs in a fingerprint region, and no valid information can be obtained. However, when the content of the additive C is measured by using the infrared optical window provided in this application, abundant fingerprint region signals of the additive C can be obtained.

### Comparative Example 2

In Comparative Example 2, an electroplating solution in which an additive A is at a concentration of 20 ppb is tested by using a CVS method. A test result is 131 ppb. It can be learned that the concentration of the additive A in the electroplating solution cannot be accurately measured by using the CVS method.

In the foregoing embodiments, descriptions for all embodiments have respective focuses. For a part that is not described in detail in an embodiment, refer to related descriptions in other embodiments.

Although this application is described with reference to specific features and embodiments thereof, it is clearly that various modifications and combinations may be made to the specific features and the embodiments without departing from the spirit and scope of this application. Correspondingly, the specification and accompanying drawings are merely example descriptions of this application defined by the appended claims, and are considered as any of or all modifications, variations, combinations, or equivalents that cover the scope of this application. It is clearly that a person skilled in the art can make various modifications and variations to this application without departing from the spirit and scope of this application. In this way, this application is intended to cover these modifications and variations of this application provided that they fall within the scope of protection defined by the following claims and their equivalent technologies.

What is claimed is:

1. A substance component detection apparatus, comprising:
a sample pool, configured to accommodate a to-be-detected substance, wherein the sample pool has an opening;
an infrared optical window, mounted at the opening, wherein the infrared optical window has a first surface that faces an inner side of the sample pool and that is configured to be in contact with the to-be-detected substance, and a second surface exposed on an outer side of the sample pool, a plurality of grooves are formed on the second surface, a protruding portion is formed between two adjacent grooves, and the protruding portion has an incident surface and an emergent surface that are opposite to each other;
an infrared light source, wherein an infrared signal emitted by the infrared light source is irradiated on the incident surface and reaches the first surface; and
a detector, wherein the detector is configured to receive the infrared signal that is reflected by the first surface and that is emitted through the emergent surface, to determine at least one component of the to-be-detected substance and content of the at least one component.

2. The substance component detection apparatus according to claim 1, wherein the plurality of grooves are strip-shaped grooves, and the plurality of strip-shaped grooves extend in a same direction.

3. The substance component detection apparatus according to claim 2, wherein the plurality of strip-shaped grooves are distributed in an array in a direction perpendicular to the extension direction of the strip-shaped grooves.

4. The substance component detection apparatus according to claim 2, wherein a cross-section of each of the plurality of strip-shaped grooves in a direction perpendicular to the second surface is trapezoidal or triangular, and included angles between the second surface and both the incident surface and the emergent surface are both acute angles.

5. The substance component detection apparatus according to claim 4, wherein a ratio of a spacing between two adjacent strip-shaped grooves to a top width of the grooves is 0.5 to 40.

6. The substance component detection apparatus according to claim 1, wherein a size of the infrared optical window in an extension direction of the groove ranges from 2 mm to 11 mm, and a size of the infrared optical window in a direction perpendicular to the extension direction of the groove ranges from 2 mm to 11 mm.

7. The substance component detection apparatus according to claim 1, wherein the second surface comprises a first region and a second region surrounding a periphery of the first region; and the plurality of grooves are formed in the first region.

8. The substance component detection apparatus according to claim 7, wherein a minimum distance between a boundary line of a side of the second region that is away from the first region and a boundary line of the first region is greater than a preset distance.

9. The substance component detection apparatus according to claim 1, wherein a material of the infrared optical window is monocrystalline silicon or polycrystalline silicon.

10. The substance component detection apparatus according to claim 1, wherein a surface-enhanced infrared effect thin film is formed on the first surface, and the surface-enhanced infrared effect thin film is configured to amplify an infrared signal of the at least one component of the to-be-detected substance that is adsorbed on the first surface.

11. The substance component detection apparatus according to claim 10, wherein the surface-enhanced infrared effect thin film is a nano gold layer or a nano copper layer.

12. The substance component detection apparatus according to claim 10, wherein the substance component detection apparatus is an electroplating solution component detection apparatus, and the electroplating solution component detection apparatus further comprises:
an electrical signal applicator, wherein the electrical signal applicator is electrically connected to the surface-enhanced infrared effect thin film, and the electrical signal applicator is configured to apply an electrical signal to the surface-enhanced infrared effect thin film, so that the surface-enhanced infrared effect thin film is used as a working electrode.

13. The substance component detection apparatus according to claim 12, wherein the electroplating solution component detection apparatus further comprises:
a counter electrode, electrically connected to the electrical signal applicator, wherein the counter electrode is configured to form an electrical loop with the working electrode; and
a reference electrode, electrically connected to the electrical signal applicator, wherein the reference electrode is configured to obtain an electric potential of the working electrode.

14. A method for detecting a component of a to-be-detected substance using a substance component detection apparatus, wherein the substance component detection apparatus comprises:
a sample pool, configured to accommodate a to-be-detected substance, wherein the sample pool has an opening;
an infrared optical window, mounted at the opening, wherein the infrared optical window has a first surface that faces an inner side of the sample pool and that is configured to be in contact with the to-be-detected substance, and a second surface exposed on an outer side of the sample pool, a plurality of grooves are formed on the second surface, a protruding portion is formed between two adjacent grooves, and the protruding portion has an incident surface and an emergent surface that are opposite to each other;
an infrared light source, wherein an infrared signal emitted by the infrared light source is irradiated on the incident surface and reaches the first surface; and
a detector, wherein the detector is configured to receive the infrared signal that is reflected by the first surface and that is emitted through the emergent surface; and
the method comprises:
emitting, by the infrared light source, the infrared signal, wherein the infrared signal is irradiated on the incident surface and reaches the first surface;
receiving, by the detector, the infrared signal that is reflected by the first surface and that is emitted through the emergent surface; and
determining at least one component of the to-be-detected substance and content of the at least one component based on the infrared signal received by the detector.

15. The method for detecting a component of a to-be-detected substance using a substance component detection apparatus according to claim 14, wherein a surface-enhanced infrared effect thin film is formed on the first surface, and the surface-enhanced infrared effect thin film is configured to amplify an infrared signal of the at least one component of the to-be-detected substance that is adsorbed on the first surface.

16. The method for detecting a component of a to-be-detected substance using a substance component detection apparatus according to claim 15, wherein the substance component detection apparatus is an electroplating solution component detection apparatus, and the electroplating solution component detection apparatus further comprises:
an electrical signal applicator, wherein the electrical signal applicator is electrically connected to the surface-enhanced infrared effect thin film; and
the to-be-detected substance is a to-be-detected electroplating solution, and based on the at least one component of the to-be-detected electroplating solution and content of the at least one component being detected, the method comprises:
applying, by the electrical signal applicator, an electrical signal to the surface-enhanced infrared effect thin film, so that the surface-enhanced infrared effect thin film is used as a working electrode, and an electrochemical reaction occurs on the at least one component of the to-be-detected electroplating solution on the working electrode.

17. The method for detecting a component of a to-be-detected substance using a substance component detection apparatus according to claim 16, wherein based on the at least one component of the to-be-detected electroplating solution and content of the at least one component being detected, determining content of a target component of the to-be-detected electroplating solution based on the infrared signal received by the detector comprises:
obtaining an infrared absorption spectrum of the to-be-detected electroplating solution based on the infrared signal received by the detector;
obtaining a characteristic absorption peak area of the target component in the infrared absorption spectrum based on a characteristic absorption peak of the target component in the infrared absorption spectrum; and
determining the content of the target component of the electroplating solution based on the characteristic absorption peak area of the target component in the infrared absorption spectrum and a relationship between the content of the target component and the characteristic absorption peak area.

18. The method for detecting a component of a to-be-detected substance using a substance component detection apparatus according to claim 17, wherein the relationship between the content of the target component and the characteristic absorption peak area is obtained by performing the following operations:
preparing standard solutions of the target component at a plurality of concentrations, where the target component is any component of the to-be-detected electroplating solution;
detecting the standard solutions at the plurality of concentrations in a sequence using the electroplating solution component detection apparatus, to obtain infrared absorption spectrums of the standard solutions at the plurality of concentrations;
for the infrared absorption spectrum of the standard solution at each concentration, obtaining, based on a characteristic absorption peak of the target component in the infrared absorption spectrum, a characteristic absorption peak area corresponding to the standard solution at each concentration; and
determine the relationship between the concentration of the target component and the characteristic absorption peak area based on the characteristic absorption peak area corresponding to the standard solution at each concentration.

19. A substance component detection system, comprising a substance component detection apparatus and an electroplating host, wherein the substance component detection apparatus is integrated in the electroplating host, wherein the substance component detection apparatus comprises:
a sample pool, configured to accommodate a to-be-detected substance, wherein the sample pool has an opening;
an infrared optical window, mounted at the opening, wherein the infrared optical window has a first surface that faces an inner side of the sample pool and that is configured to be in contact with the to-be-detected substance, and a second surface exposed on an outer side of the sample pool, a plurality of grooves are formed on the second surface, a protruding portion is formed between two adjacent grooves, and the protruding portion has an incident surface and an emergent surface that are opposite to each other;
an infrared light source, wherein an infrared signal emitted by the infrared light source is irradiated on the incident surface and reaches the first surface; and
a detector, wherein the detector is configured to receive the infrared signal that is reflected by the first surface and that is emitted through the emergent surface, to determine at least one component of the to-be-detected substance and content of the at least one component.

20. The substance component detection system according to claim 19, wherein the substance component detection apparatus performs a method for detecting a component of a to-be detected substance, including:
emitting, by the infrared light source, the infrared signal, wherein the infrared signal is irradiated on the incident surface and reaches the first surface;
receiving, by the detector, the infrared signal that is reflected by the first surface and that is emitted through the emergent surface; and
determining at least one component of the to-be-detected substance and content of the at least one component based on the infrared signal received by the detector.
